(19) United States
(12) Patent Application Publication
(10) Pub. No.: US 2014/0334186 A1
(43) Pub. Date: Nov. 13, 2014

(54) ENERGY-SAVING POWER CONVERTER

(71) Applicant: CHICONY POWER TECHNOLOGY CO., LTD., New Taipei City (TW)

(72) Inventor: Shih-Min LIN, New Taipei City (TW)

(73) Assignee: Chicony Power Technology Co., Ltd., New Taipei City (TW)

(21) Appl. No.: 13/889,491

(22) Filed: May 8, 2013

(51) Int. Cl. H02M 3/315; H02M 3/335

(52) U.S. Cl. CPC H02M 3/3155; H02M 3/33507
USPC 363/16; 363/15

(57) ABSTRACT

An energy-saving power converter includes a first switch unit, a transformer primary side, a transformer secondary side, a diode subunit, a switch subunit, a comparison unit, a current sensor, and a resistor. The transformer primary side starts storing energy when the first switch unit is turned on. The transformer secondary side sends a secondary side current to the current sensor through the diode subunit when the first switch unit is turned off. The current sensor informs the comparison unit and the resistor when the current sensor senses the secondary side current. The resistor is used to transform the secondary side current into voltage form for entering the comparison unit. The comparison unit is configured to turn on the switch subunit, so that the secondary side current is passing through the switch subunit.

### BACKGROUND OF THE INVENTION

1. Field of the Invention

The present invention relates to a power converter, and especially relates to an energy-saving power converter.

2. Description of the Related Art

FIG. 2 shows a block diagram of the related art power converter. A related art power converter 50 is applied to a power supply apparatus 20 and a load apparatus 30. The related art power converter 50 is, for example, a flyback converter.

The related art power converter 50 includes a transformer 102, a first switch unit 104, a first switch controller 114, a diode 52, and an output side capacitor 118. The transformer 102 includes a transformer primary side 120 and a transformer secondary side 122.

The transformer primary side 120 is electrically connected to the power supply apparatus 20 and the first switch unit 104. The first switch controller 114 is electrically connected to the first switch unit 104. The diode 52 is electrically connected to the transformer secondary side 122, the output side capacitor 118, and the load apparatus 30.

The transformer primary side 120 starts storing energy when the first switch unit 104 is turned on (controlled by the first switch controller 114). The transformer secondary side 122 starts releasing energy through the diode 52 when the first switch unit 104 is turned off (controlled by the first switch controller 114). The content mentioned above is the basic working principle of the conventional flyback converter.

The structure of the related art power converter 50 mentioned above is very simple. However, the disadvantage of the related art power converter 50 mentioned above is that the power consumption of the diode 52 is still too high.

### SUMMARY OF THE INVENTION

In order to solve the above-mentioned problems, an object of the present invention is to provide an energy-saving power converter.

In order to achieve the object of the present invention mentioned above, the energy-saving power converter is applied to a power supply apparatus and a load apparatus. The energy-saving power converter includes a transformer, a first switch unit, a second switch unit, a comparison unit, a current sensor, and a resistor. The transformer includes a transformer primary side and a transformer secondary side. The second switch unit includes a diode subunit and a switch subunit. The comparison unit includes a comparison unit output side, a comparison unit first input side, and a comparison unit second input side. The transformer primary side is electrically connected to the power supply apparatus. The first switch unit is electrically connected to the transformer primary side. The diode subunit is electrically connected to the transformer secondary side. The switch subunit is electrically connected to the transformer secondary side and the diode subunit. The comparison unit output side is electrically connected to the switch subunit. The current sensor is electrically connected to the diode subunit, the switch subunit, the comparison unit first input side, the comparison unit second input side, and the load apparatus. The resistor is electrically connected to the comparison unit first input side, the comparison unit second input side, and the current sensor. The transformer primary side starts storing energy when the first switch unit is turned on. The transformer secondary side sends a secondary side current to the current sensor through the diode subunit when the first switch unit is turned off. The current sensor informs the comparison unit and the resistor when the current sensor senses the secondary side current. The resistor is used to transform the secondary side current into voltage form for entering the comparison unit. The comparison unit is configured to turn on the switch subunit, so that the secondary side current is passing through the switch subunit.

### BRIEF DESCRIPTION OF DRAWING

FIG. 1 shows a block diagram of the energy-saving power converter of the present invention.

FIG. 2 shows a block diagram of the related art power converter.

### DETAILED DESCRIPTION OF THE INVENTION

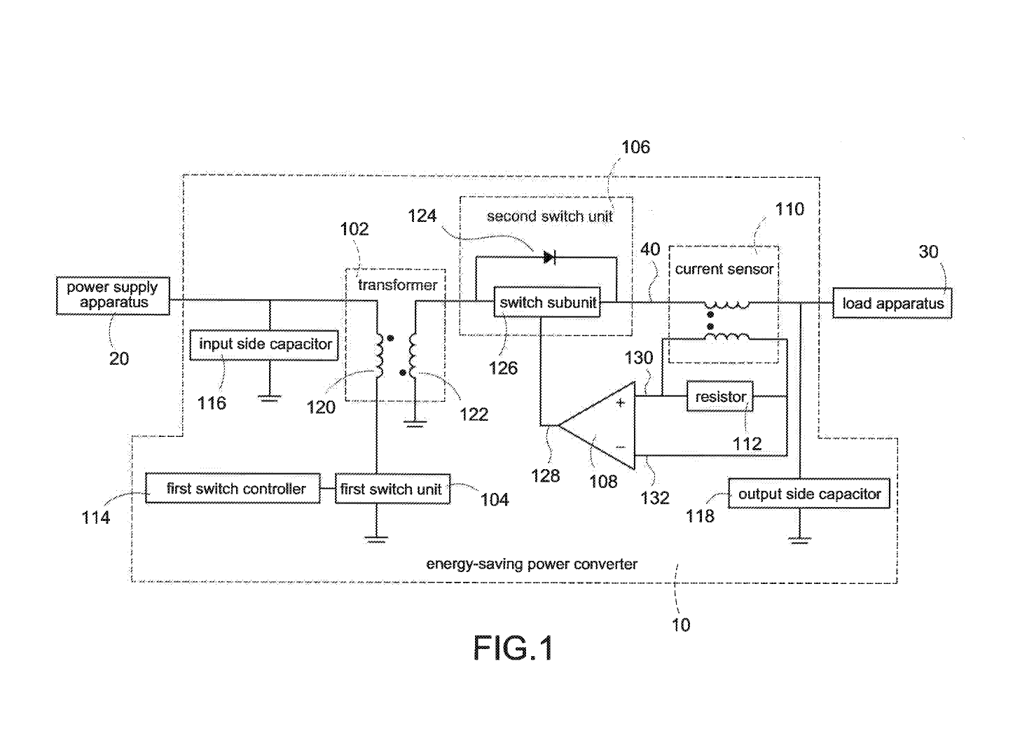

FIG. 1 shows a block diagram of the energy-saving power converter of the present invention. An energy-saving power converter 10 is applied to a power supply apparatus 20 and a load apparatus 30.

The energy-saving power converter 10 includes a transformer 102, a first switch unit 104, a second switch unit 106, a comparison unit 108, a current sensor 110, a resistor 112, a first switch controller 114, an input side capacitor 116, and an output side capacitor 118.

The transformer 102 includes a transformer primary side 120 and a transformer secondary side 122. The second switch unit 106 includes a diode subunit 124 and a switch subunit 126. The comparison unit 108 includes a comparison unit output side 128, a comparison unit first input side 130, and a comparison unit second input side 132.

The transformer primary side 120 is electrically connected to the power supply apparatus 20. The first switch unit 104 is electrically connected to the transformer primary side 120. The diode subunit 124 is electrically connected to the transformer secondary side 122. The switch subunit 126 is electrically connected to the transformer secondary side 122 and the diode subunit 124.

The comparison unit output side 128 is electrically connected to the switch subunit 126. The current sensor 110 is electrically connected to the diode subunit 124, the switch subunit 126, the comparison unit first input side 130, the comparison unit second input side 132, and the load apparatus 30.

The resistor 112 is electrically connected to the comparison unit first input side 130, the comparison unit second input side 132, and the current sensor 110. The first switch controller 114 is electrically connected to the first switch unit 104. The input side capacitor 116 is electrically connected to the power supply apparatus 20 and the transformer primary side 120. The output side capacitor 118 is electrically connected to the current sensor 110 and the load apparatus 30.

The transformer primary side 120 starts storing energy when the first switch unit 104 is turned on (controlled by the first switch controller 114). The transformer secondary side 122 sends a secondary side current 40 (namely, provides energy) to the load apparatus 30 through the diode subunit 124 when the first switch unit 104 is turned off (controlled by the first switch controller 114). The content mentioned above is the basic working principle of the conventional flyback converter.

The transformer secondary side 122 sends the secondary side current 40 to the current sensor 110 through the diode subunit 124 when the first switch unit 104 is turned of (controlled by the first switch controller 114). In another word, the transformer secondary side 122 starts releasing energy through the diode subunit 124 when the first switch unit 104 is turned off.

The current sensor 110 informs the comparison unit 108 and the resistor 112 when the current sensor 110 senses the secondary side current 40. The current sensor 110 (for example but not limited to) converts the secondary side current 40 into a small current. The resistor 112 is used to transform the secondary side current 40 (or the small current mentioned above) into voltage form for entering the comparison unit 108.

The comparison unit 108 is configured to turn on (for example, output a high electric potential) the switch subunit 126 through the comparison unit output side 128 according to the voltage difference between the comparison unit first input side 130 and the comparison unit second input side 132. Therefore, the secondary side current 40 is passing through the switch subunit 126. Namely, the secondary side current 40 is almost not passing through the diode subunit 124.

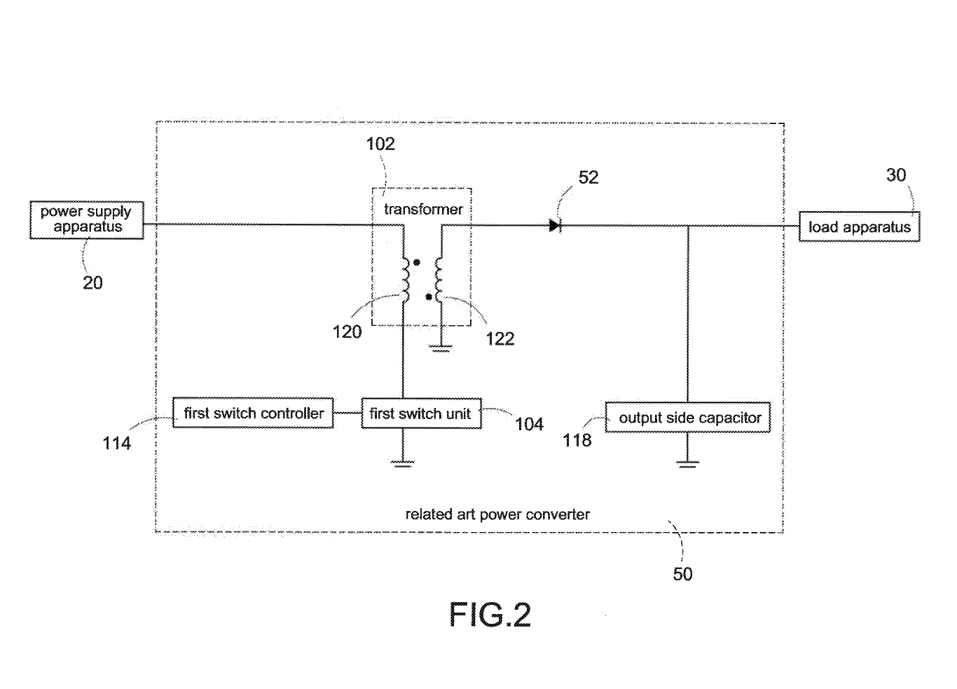

The power consumption of the switch subunit 126 is less than the power consumption of the diode subunit 124 (or the conventional diode). Therefore, the power consumption of the energy-saving power converter 10 is less than the power consumption of the related art power converter 50 shown in FIG. 2 (the current is passing through the diode 52).

The current sensor 110 is, for example but not limited to, a current transformer or a Hall effect current transducer. The comparison unit 108 is, for example but not limited to, a comparator, a power amplifier comparator circuit, or a differential comparator circuit.

The comparison unit output side 128 is a comparator output side if the comparison unit 108 is a comparator. The comparison unit first input side 130 is a comparator non-inverting input side. The comparison unit second input side 132 is a comparator inverting input side.

The first switch unit 104 is, for example but not limited to, a metal oxide semiconductor field effect transistor, an insulation gate bipolar transistor, or a silicon controlled rectifier.

The transformer 102 is, for example but not limited to, a flyback transformer, a forward transformer, an inductor-inductor-capacitor resonant transformer, or a push pull transformer.

Moreover, the second switch unit 106 is an electronic component with a built-in diode, or an electronic component without a built-in diode.

The second switch unit 106 is, for example but not limited to, a metal oxide semiconductor field effect transistor, if the second switch unit 106 is an electronic component with a built-in diode.

The switch subunit 126 is, for example but not limited to, a bipolar junction transistor, an insulation gate bipolar transistor, or a silicon controlled rectifier, if the second switch unit 106 is an electronic component without a built-in diode. And, the diode subunit 124 is, for example but not limited to, a diode.

Moreover, the second switch unit 106 and the current sensor 110 could be arranged at the low voltage side of the transformer secondary side 122 as well.

The present invention includes following features.

1. The transformer secondary side 122 sends the secondary side current 40 to the current sensor 110 through the diode subunit 124 when the first switch unit 104 is turned off. The current sensor 110 informs the comparison unit 108 and the resistor 112. The comparison unit 108 is configured to turn on the switch subunit 126, so that the secondary side current 40 is passing through the switch subunit 126.

2. The power consumption of the switch subunit 126 is less than the power consumption of the diode subunit 124 (or the conventional diode). Therefore, the power consumption of the energy-saving power converter 10 is less than the power consumption of the related art power converter 50 shown in FIG. 2 (the current is passing through the diode 52).

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is

1. An energy-saving power converter applied to a power supply apparatus and a load apparatus, the energy-saving power converter including:
a transformer having a transformer primary side and a transformer secondary side, the transformer primary side electrically connected to the power supply apparatus;
a first switch unit electrically connected to the transformer primary side;
a second switch unit having a diode subunit and a switch subunit, the diode subunit electrically connected to the transformer secondary side, the switch subunit electrically connected to the transformer secondary side and the diode subunit;
a comparison unit having a comparison unit output side, a comparison unit first input side, and a comparison unit second input side, the comparison unit output side electrically connected to the switch subunit;
a current sensor electrically connected to the diode subunit, the switch subunit, the comparison unit first input side, the comparison unit second input side, and the load apparatus; and
a resistor electrically connected to the comparison unit first input side, the comparison unit second input side, and the current sensor,
wherein the transformer primary side starts storing energy when the first switch unit is turned on; the transformer secondary side sends a secondary side current to the current sensor through the diode subunit when the first switch unit is turned off; the current sensor informs the comparison unit and the resistor when the current sensor senses the secondary side current; the resistor is used to transform the secondary side current into voltage form for entering the comparison unit; the comparison unit is configured to turn on the switch subunit, so that the secondary side current is passing through the switch subunit.

2. The energy-saving power converter in claim 1, further including a first switch controller electrically connected to the first switch unit.

3. The energy-saving power converter in claim 2, further including an input side capacitor electrically connected to the power supply apparatus and the transformer primary side.

4. The energy-saving power converter in claim 3, further including an output side capacitor electrically connected to the current sensor and the load apparatus.

5. The energy-saving power converter in claim 4, wherein the current sensor is a current transformer or a Hall effect current transducer.

6. The energy-saving power converter in claim 4, wherein the comparison unit is a power amplifier comparator circuit or a differential comparator circuit.

7. The energy-saving power converter in claim 4, wherein the comparison unit is a comparator; the comparison unit output side is a comparator output side; the comparison unit first input side is a comparator non-inverting input side; the comparison unit second input side is a comparator inverting input side.

8. The energy-saving power converter in claim 4, wherein the first switch unit is a metal oxide semiconductor field effect transistor, an insulation gate bipolar transistor, or a silicon controlled rectifier; the transformer is a flyback transformer, a forward transformer, an inductor-inductor-capacitor resonant transformer, or a push pull transformer,

9. The energy-saving power converter in claim 4, wherein the second switch unit is a metal oxide semiconductor field effect transistor.

10. The energy-saving power converter in claim 4, wherein the switch subunit is a bipolar junction transistor, an insulation gate bipolar transistor, or a silicon controlled rectifier; the diode subunit is a diode.
